(19) United States
(12) Patent Application Publication
(10) Pub. No.: US 2006/0254467 A1
(43) Pub. Date: Nov. 16, 2006

(54) Method for making spray-dried cement particles

(76) Inventors: Isaac Farr, Corvallis, OR (US); Daniel A. Kearl, Philomath, OR (US); William Carty, Alfred, NY (US); Hyojin Lee, Alfred, NY (US); Ungsoo Kim, Alfred, NY (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/128,681

(22) Filed: May 13, 2005

(51) Int. Cl. C04B 24/00; C04B 2/10

(52) U.S. Cl. 106/728; 106/756; 106/810

(57) ABSTRACT

A cement composition comprises free-flowing spray-dried unreacted cement particles and a liquid binder. The spray-dried particles may include a poly acid. A method for making a cement composition using spray dried cement particles comprises a) providing cement particles, b) milling or sieving said cement particles so as to produce cement particles having a desired average size, c) adding a liquid carrier to said particles before or after milling so as to form a slurry, d) adding a poly acid to said particles while maintaining the pH of the slurry above about 6, and e) spray-drying the slurry. The resulting particles can be used in conjunction with a liquid binder to form a monolith having a desired shape.

### BACKGROUND

The efficient production of prototype or other three-dimensional objects can provide an effective means of reducing the time it takes to bring a product to market at a reasonable cost. Conventional approaches for preparing prototypes have required machining either the prototype itself or specific tooling, e.g., molds and dies, for forming the prototype. Thus, construction of a prototype can be a slow and cumbersome process.

Recently, computerized modeling has alleviated some of the need for building prototypes. Computer modeling can be carried out quickly, and provide a good idea of what a product will look like, without a specialized tooling requirement. However, the fabrication of a tangible object is still often preferred for prototyping. The merging of computer modeling and the physical formation of three-dimensional objects is sometimes referred to as desktop manufacturing. Various techniques that employ desktop manufacturing have been explored and described in the literature.

In this evolving area of technology, there has been a desire to provide new methods of manufacture that are relatively easy to employ, provide rigid structures, and are able to form three-dimensional objects relatively quickly. One such method involves the steps of depositing a particulate cement composition in a defined region; ink-jetting a liquid binder onto a predetermined area of the particulate composition to form hydrated cement in the predetermined area; hardening the hydrated cement; and repeating these steps such that a monolithic object having the desired three dimensional shape is formed.

It has been found, however, that the particulate layers cannot be rapidly deployed with the desired level of control and uniformity unless the cement particles themselves are sufficiently uniform and flowable. It has been further found that non-spherical particles having a large size range, such as are generated by conventional processes tend to clump and resist flowing in a controlled, even manner.

Thus, additional methods, systems, and/or compositions that provide improved cement particles would be an advancement in the art.

### BRIEF SUMMARY

The problems noted above are solved in large part by milling the cement particles to a uniform reduced size and by spray-drying a slurry containing the milled cement particles to form relatively uniform dry cement particles. Undesired early reaction of the cement particles in the slurry during mixing and spray-drying can be mitigated by maintaining the pH of the slurry above a predetermined level. In some embodiments this is achieved by using a salt of a poly-acid in the slurry. The salt dissociates without decreasing the pH of the slurry and so does not cause the accelerated setting that would otherwise occur. In this manner, a spray-dryable cement composition comprising unreacted cement particles and a salt of a poly-acid is formed.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .”

The use of the term “cement,” in accordance with embodiments of the present invention, is intended to include in particular hydrated compositions that contain inorganic phosphates and in general particulate compositions that react in the presence of water to form a solid. The cement can be in a wet state, or in a hardened or cured state.

The term “dry cement particles” is used to describe dry particulate compositions that can be hydrated to form cement.

The term “particulate” includes fine dry powders and/or crystals.

The term “colorant” includes both pigments and dyes.

The terms “harden” or “hardening” includes a state of cement setting from the beginning stages of setting to a completely hardened or cured state.

As used herein, “liquid binder” refers to a liquid that will react with dry cement particles to form a cement and can be prepared for jetting from ink-jet architecture.

As used herein, “poly-acid” refers to a polymer having at least one acid functionality.

The term “predetermined area,” is used herein in the context of layering of cement in incremental cross-sections so as to form a three-dimensional object. The predetermined area is a cross-section of the desired object and can vary from layer to layer. The shape of the predetermined area of each layer of cement is defined such that upon completion of all layers a three-dimensional object having the desired shape is formed.

The term “slurry” or “cement slurry” is used herein to refer to a spray-dryable mixture comprising at least cement particles in a liquid carrier.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The present specification describes a cement composition that is well-suited for use in freeform fabrication systems. The particulate portion of the cement is free-flowing and uniform and includes unreacted cement particles. The liquid portion of the cement is compatible with inkjet systems such as, in a non-limiting example, drop-on-demand systems and can be used in freeform fabrication systems that incorporate an inkjet print head.

It has been found that the quality of objects formed using freeform fabrication systems is lacking when conventional dry calcium phosphate cement particles are used, inasmuch as the particles tend to be non-uniform and to clump such that it is difficult to quickly and effectively deploy a uniform layer onto the object being formed. It has been found that these problems can be mitigated by milling the particles so as to achieve a desired level of uniformity in the particle size and/or by spray-drying a slurry of the milled particles so as to form dry cement particles, which can then be used in the freeforming process. The dry cement particles formed by spray-drying are generally spherical and tend to be uniform in size.

Milling can be achieved using any suitable apparatus, including but not limited to ball mills, hammer mills, vibratory mills, and the like. Up to a point, longer milling periods tend to produce smaller average particle sizes and increase the surface area of the particulate matter. In certain embodiments, unreacted cement particles for use with the present invention can be milled until 50% of the particles are smaller than 3 μm. In other embodiments, 50% of the particles are smaller than 2 μm or smaller than 1 μm. Because milling particles to this size takes time, it becomes more important to suppress any tendency of the particles to react. Alternatively or in addition, an initial amount of cement particles having a range of sizes can be sieved so as to produce cement particles having a desired average size and a narrow size distribution.

Offsetting the advantages gained by milling is the fact that certain reagents that are useful in the cementing reaction, such as poly acids and other accelerants, if present during milling or mixing, tend to accelerate setting of the slurry, which is undesirable. For example, poly(acrylic acid) (PAA) is often used to facilitate the setting reactions of phosphate cements. When PAA is present in the spray-drying slurry, it reduces the pH of the slurry and contributes to undesired early setting.

It has been found that this undesirable early setting of the slurry can be reduced or prevented by providing the poly-acid to the spray-drying slurry as a salt. Because it is not in its protonated form, the dissociation of the poly-acid in the slurry does not reduce the pH of the slurry. In turn, the cement particles in the slurry remain unreacted during mixing and retain their functionality after spray-drying is complete. In certain embodiments, the poly-acid salt is a sodium or ammonium salt. In other embodiments, suitable salts of the poly-acid can be formed with other monovalent cations.

Alternatively, setting of the cement slurry can be avoided by using an additional base or buffer to maintain the pH of the slurry above a minimum level. It is believed that in most instances, maintaining the pH of the slurry above 6 will suffice to prevent setting. In certain instances, maintaining the pH of the slurry above 8, or above 9, will give better results. Examples of suitable bases include but are not limited to ammonia, calcium hydroxide, and sodium hydroxide. Examples of other suitable bases include but are not limited to piperazine-1,4-bis(2-ethanesulfonic acid) (PIPES), tris(hydroxymethyl)aminomethane, ammonia, borate, and diethylamine.

During milling and mixing, the unreacted cement particles can be present in a liquid carrier such as water. In other embodiments, milling and/or mixing can be carried out in the absence of a liquid. Regardless, a liquid carrier is added prior to spray-drying and together the cement particles, the additional ingredients and the liquid carrier form a flowable, pumpable slurry. As discussed herein, additional ingredients such as accelerators, strengtheners, and pH additives may be included.

Spray-drying of the slurry may be carried out using conventional spray-drying nozzles, nozzle pressures, and orifice sizes. It has been found that providing a dryer gas stream heated to between about 200° C. and 350° C. and maintaining a spray-drying outlet temperature between about 50° C. and 150° C. ensures adequate flowability and drying of the slurry, but it will be understood that any suitable spray drying conditions may be used. The resulting dry cement particles flow well and can readily be deployed in a uniform layer as part of a freeforming process or the like.

In a free forming process, layers of spray-dried particles can be applied to a desired platform or substrate alternately with applications of liquid binder so as to build up a three-dimensional object have a desired shape. The liquid binder can be applied in a predetermined area using inkjet systems such as, by way of example only, drop-on-demand systems.

Dry Cement Particles

The present invention can be used in conjunction with any cement formulation that includes a poly-acid. Inorganic cements including but not limited to calcium phosphates and calcium sulfate cements can benefit from the present invention, as can hydraulic cements and the like.

If inorganic phosphate cement particles are used, they can be present in the particulate composition at from 20 wt % to 100 wt % and can have an average particulate size from 0.1 microns to 1000 microns. In certain embodiments, the particulate cement composition can comprise one or more calcium phosphate compounds. Examples include monocalcium phosphate, dicalcium phosphate, tricalcium phosphate, tetracalcium phosphate, or hydroxyapatite. Other phosphates including magnesium phosphate, strontium phosphate, barium phosphate, or alkali metal phosphates can alternatively or additionally be used in various formulations as well. Addition of one or more of these alternative phosphates (particularly strontium and barium) can enable detection or tracking by radiographic means, should such be desired.

In some embodiments, it may be desirable to include in the cement one or more active pharmaceutical ingredients, also referred to herein as bioactive agents, such as antibacterial, antitumor, analgesic, or immunosuppressive agents. In these cases, the bioactive agent can be added to the slurry before spray-drying, to the spray-dried particles before or after they are deployed, or to the liquid binder.

In addition to the afore-mentioned additives, other particulate components may also be present in the particulate composition, such as ordinary Portland dry cement mix, ferrite dry cement mix, sulfoferrite, sulfoaluminoferrite, nanofillers, plasticizers, crosslinking agents, polymers, and drying and setting accelerators.

In some embodiments, polymeric particulates can also be present in the particulate composition. Examples of such polymeric particulates include 75% to 100% hydrolyzed polyvinyl alcohol powder, polyacrylamide powder, poly(acrylic acid), poly(acrylamide-co-acrylic acid), poly(vinyl alcohol-co-ethylene), poly(vinyl alcohol-co-vinyl acetate-co-itaconic acid), poly(vinyl pyrrolidone), poly(methylmethacrylate-co-methacrylic acid), soluble starch, methylcellulose, and combinations thereof. The weight average molecular weight of such polymeric particulates can be from 2,000 Mw to 1,000,000 Mw. In a more detailed aspect, the polymeric particulates can be from 2,000 Mw to 150,000 Mw. The polymeric particulates can have an average particulate size from 5 microns to 80 microns. The use of the polymeric particulates can provide for crosslinking or other reactions within the particulate composition upon application of the aqueous liquid, thereby improving hardening and strength-building of the three-dimensional object.

Liquid Binder

The liquid portion of the cement can be any liquid that will react with the spray-dried cement particles and can be prepared for jetting from ink-jet architecture. In many embodiments, water will be a primary component of the liquid binder. Other compounds that can be present in a liquid binder are well known in the ink-jet arts, and a wide variety of such components can be used with the systems and methods of the present invention. These other compounds may be present to alter the pH, improve jettability properties, alter the properties of the resulting object (such as strength), alter the hardening properties of the cement (such as hardening accelerators), and the like. Examples of such added components include a variety of different agents, including surfactants, organic solvents and co-solvents, buffers, biocides, sequestering agents, viscosity modifiers, low molecular weight polymers, lithium ion sources, etc. Colorant can optionally be added to the aqueous liquid as well.

In certain embodiments, the liquid binder may include a dilute acid, such as phosphoric acid, which promotes setting by decreasing the pH of the wet cement. In some of these embodiments, the acid in the binder may be sufficient to reduce the pH of the cement below 6.

### EXAMPLE

The example that follows is intended to illustrate but not limit the present invention.

To prepare a batch of slurry, 1000 g of tetracalcium phosphate (TTCP) cement particles were pre-milled in water for 30 minutes using a vibratory mill. The pH of the slurring during pre-milling was ˜12.0. At the end of the milling, the cement particles had a specific surface area of 5.5 m²/g and an average size between 10 and 12 μm. 138.9 g lithium phosphate and 41.7 g magnesium fluoride were added to the pre-milled suspension, causing the pH to drop to ˜11.6. The suspension was then milled for an additional 30 minutes, after which the surface area was 10.6 m²/g and the average size between 10 and 11 μm. 138.9 g NH₄—PAA (Darvan 821A) in aqueous solution (43 wt. %) and 69.4 g citric acid were added to the slurry, causing the pH to drop to ˜6.5. Lithium hydroxide was added to adjust the pH to ˜7.0 and the resulting mixture was mixed for one hour using an impeller mixer. Following mixing, the slurry was spray-dried, using an inlet temperature of 300° C. and an outlet temperature of 95° C. SEM images of the resulting spray-dried particles showed generally spherical shapes.

The above discussion is meant to be illustrative of the principles and various embodiments of the present invention. Numerous variations and modifications will become apparent to those skilled in the art once the above disclosure is fully appreciated. Likewise, the sequential recitation of steps in a claim is not intended as a requirement that the steps be performed sequentially, nor that a particular step be commenced before another step is completed. It is intended that the following claims be interpreted to embrace all such variations and modifications.

What is claimed is:

1. A cement composition, comprising:
spray-dried unreacted cement particles; and
a liquid binder.

2. The cement composition of claim 1 wherein the liquid binder is acidic.

3. The cement composition of claim 1 wherein the spray-dried particles include a poly acid.

4. The cement composition of claim 1 wherein the spray-dried particles have a size distribution such that a free-flowing powder is produced.

5. A method for making a cement composition using spray-dried cement particles, comprising:
a) providing cement particles;
b) milling or sieving said cement particles so as to produce cement particles having a desired average size;
c) adding a liquid carrier to said particles before or after milling so as to form a slurry;
d) adding a poly acid to said particles while maintaining the pH of the slurry above about 6; and
e) spray-drying the slurry.

6. The method of claim 5 wherein the pH of the slurry is maintained by adding said poly acid as a salt.

7. The method of claim 5 wherein said poly acid is poly(acrylic acid).

8. The method of claim 5 wherein the pH of the slurry is maintained by adding a base or a buffer to said slurry.

9. A method for solid free-form fabrication of a three-dimensional object, comprising:
a) providing cement particles;
b) milling or sieving said cement particles so as to produce cement particles having a desired average size;
c) adding a liquid carrier to said particles before or after milling so as to form a slurry;
d) spray-drying the slurry so as to substantially remove the carrier and form dry cement particles;
e) depositing the cement particles in a defined region;
f) ink-jetting a liquid binder onto a predetermined area within the defined region such that upon contact of the liquid binder with the cement particles a hydrated cement forms in the predetermined area;
g) repeating steps e) through f) such that multiple layers of the cement are formed that are bound to one another, thereby forming the three dimensional object.

10. The method of claim 9 wherein the slurry includes a poly acid, further including maintaining the pH of the slurry above a predetermined level by forming said slurry from a salt of poly(acrylic acid).

11. The method of claim 9, further including adding a base or a buffer to said slurry to maintain the pH of the slurry above a predetermined level.

12. A system for solid free-form fabrication of three-dimensional objects, comprising:
a spray-dried particulate composition including milled cement particles and a poly acid;
a platform configured for supporting at least a layer of the particulate composition in a predetermined region;
a liquid binder for hydrating at least a portion of the particulate composition to form a cement; and
a system for applying the aqueous liquid to the particulate in the predetermined region.

13. The freeform fabrication system as in claim 12 wherein the spray-dried particulate composition is made from a slurry having a pH greater than 6.

14. The freeform fabrication system as in claim 12 wherein the spray-dried particulate composition is made from a slurry.

15. The freeform fabrication system as in claim 12 wherein the spray-dried particulate composition includes an active pharmaceutical ingredient.

16. The freeform fabrication system as in claim 12 where the liquid binder includes an active pharmaceutical ingredient.

17. A freeform fabrication apparatus, comprising: a liquid applicator; a liquid binder composition; a particle applicator; and spray-dried particles, wherein the spray-dried particles comprise an inorganic phosphate cement and a poly acid.

18. A freeform fabrication apparatus as in claim 17 where the liquid binder includes an active pharmaceutical ingredient.

19. A freeform fabrication apparatus as in claim 17 where spray-dried particles include an active pharmaceutical ingredient.

20. A three-dimensional monolith, comprising multiple layers of cement deposited in contact with one another, each of said multiple layers of cement formed by applying a liquid binder to a spray-dried particulate composition comprising milled cement particles and a poly acid.

21. The three-dimensional monolith as in claim 20 wherein the liquid binder is applied using a drop-on-demand inkjet system.

22. The three-dimensional monolith as in claim 20 wherein the liquid binder is applied using an inkjet system.
